(19) United States
(12) Patent Application Publication
(10) Pub. No.: US 2009/0320349 A1
(43) Pub. Date: Dec. 31, 2009

(54) Animal decoy apparatus

(76) Inventor: Rubik Darian, Glendale, CA (US)

Correspondence Address: JAMES E. BRUNTON, ESQ., P. O. BOX 29000, GLENDALE, CA, 91209, US

(21) Appl. No.: 12/215,555

(22) Filed: Jun. 26, 2008

(51) Int. Cl. A01M 31/06; A01M 31/00

(52) U.S. Cl. 43/2

(57) ABSTRACT

An animal decoy specially designed for attracting predatory animals that includes a housing having an interior chamber, the housing having a top wall having an opening therein; a multiplicity of dispersible dust particulates disposed within the interior chamber of the housing; and a particulate dispersing mechanism operably associated with the housing for acting on the dispersible dust particulates to urge the particulates through the opening in the top wall of the housing to create a simulated dust cloud.

### BACKGROUND OF THE INVENTION

1. Field of the Invention

The present invention relates generally to animal decoys. More particularly, the invention concerns a novel decoy designed to attract predators such as coyote, fox, bobcat, etc.

2. Discussion of the Prior Art

The use of decoys of various designs and configurations is known in the prior art. More particularly, a number of different types of decoys have been used in the past to attract various animals. Perhaps the best known prior art decoy is the duck decoy, which traditionally takes the form of a wooden replica of a duck that functions to attract over-flying ducks.

By way of example, U.S. Patent Publication No. 2004/0250461 issued to Dryer relates to a remotely operated mechanical strutting turkey tail decoy having a rigid stake, a hinged strutting turkey tail and a cord for raising and lowering the tail while simultaneously opening and closing the tail. Similarly, U.S. Pat. No. 6,212,816 issued to Babbitt relates to a remote controlled animated bird decoy that includes a body and an oscillating mechanism to simulate horizontal life-like movements. The oscillating mechanism oscillates the bird decoy body and includes a battery-operated motor which is remote controlled. A sensory device with memory programmed to provide oscillatory motion is connected to the motor which provides, in turn, horizontal oscillatory motion of the bird decoy body, so that the bird decoy body oscillates in a horizontal plane in relation to the ground surface simulating a turning movement of a live bird.

While the prior art devices described in the preceding paragraph are generally representative of prior art animal decoy devices, the aforementioned patents do not describe an animal decoy that is remotely similar to the novel animal decoy of the present invention.

### SUMMARY OF THE INVENTION

By way of brief summary, the animal decoy of one form of the present invention comprises a housing having an interior chamber, the housing having a top wall having an opening therein; a multiplicity of dispersible dust particulates disposed within the interior chamber of the housing; and a particulate dispersing mechanism operably associated with the housing for acting on the dispersible dust particulates to urge the particulates through the opening in the top wall of the housing.

With the forgoing in mind, it is an object of the present invention to provide a new and improved animal decoy apparatus that includes a housing having an interior chamber for containing a multiplicity of dispersible dust particulates and a particulate dispersing mechanism for acting on the dispersible particulates in a manner to urge the particulates out of the housing so as to create a dust cloud above the housing that will tend to attract an animal toward the housing.

Another object of the invention is to provide a new and improved animal decoy apparatus of the aforementioned character that uses a battery operated blower to controllably blow the dispersible particulates out of the top of the housing.

Another object of the invention is to provide a new and improved animal decoy apparatus of the character described that uses a source of compressed gas to controllably blow the dispersible particulates out of the top of the housing.

Another object of the invention is to provide a new and improved animal decoy apparatus that effectively attracts numerous types of wild animals, but is particularly well suited as a decoy apparatus for attracting predators.

Another object of the invention is to provide a new and improved animal decoy apparatus as described in the preceding paragraphs that is of a compact construction that is easy to transport and store.

Another object of the invention is to provide a new and improved animal decoy apparatus of the class described that is of a simple construction that can be easily and efficiently manufactured and marketed.

Another object of the invention is to provide a new and improved animal decoy apparatus that is of a durable and reliable construction.

The forgoing, as well as other objects of the invention will be realized by the novel animal decoy apparatus illustrated in the drawings and described in the paragraphs which follow.

### BRIEF DESCRIPTION OF THE DRAWING

FIG. 1 is a generally perspective view partly broken way to show internal construction of one form of the animal decoy apparatus of the present invention.

FIG. 2 is a generally perspective view of one form of the remote control device of the invention that is usable with the apparatus shown in FIG. 1 of the drawings.

FIG. 3 is a generally perspective view partly broken way to show internal construction of an alternate form of the animal decoy apparatus of the present invention.

FIG. 4 is a generally perspective view of one form of the remote control device of the invention that is usable with the apparatus shown in FIG. 3 of the drawings.

### DESCRIPTION OF THE INVENTION

### Definitions

As used herein, the following terms have the following meanings:

### Particulate Matter

Particulate matter means fine particles of matter including any type of particulate matter that can be dispersed in a manner to create the appearance of a dust cloud. Suitable particulate matter for use in the present invention includes fine particles of dirt, soil or sand.

### Dispersing Means

Dispersing means as used herein means any type of mechanism that will disperse the particulate matter in a manner to create the appearance of a dust cloud.

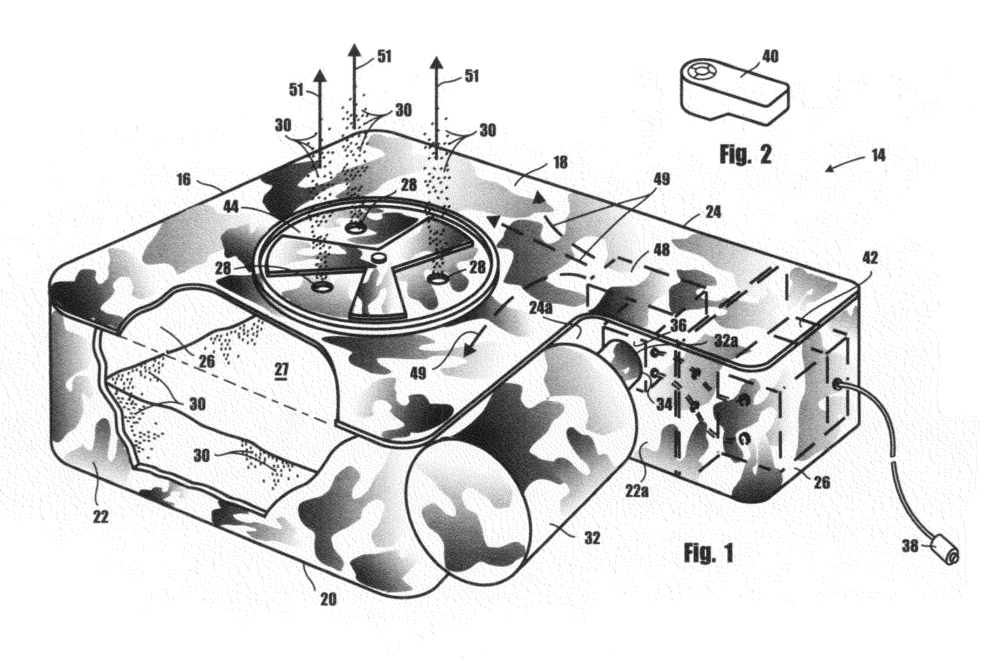

Referring to the drawings and particularly to FIGS. 1 and 2, one form of the animal decoy of the present invention is there shown and generally identified by the 14. As best seen in FIG. 1 of the drawings, the animal decoy 14 which is well suited for attracting predators comprises a housing 16 having interconnected top, bottom, front, rear and side walls 18, 20, 22, 24 and 26 respectively. As indicated in FIG. 1, interconnected walls 18, 20, 22, 24 and 26 cooperate to define an interior chamber 27. For a purpose presently to be described, top wall 18 is provided with a plurality of spaced apart openings 28.

Disposed within interior chamber 27 of housing 16 is a multiplicity of dispersible particulates generally designated by the numeral 30. Particles 30 can comprise any type of particulate matter that can be dispersed in a manner to create the appearance of a dust cloud above the housing, but here comprise fine particles of dirt or soil.

Operably associated with housing 16 is particulate dispersing means for acting on the dispersible particulates 30 to urge to be dispersible particulates through the openings 28 in said top wall 18 of the housing.

In the embodiment of the invention illustrated in FIGS. 1 and 2, the particulate dispersing means comprises a source of compressed gas, here shown as a compressed air cylinder 32 that is connected to wall 24a of the housing. Container 32 includes an outlet 32a that is in communication with an inlet 34 formed in wall 22a of housing 16. The particular dispensing means of this embodiment of the invention also includes an electrically operated valve 36 that functions to open and close the outlet of the compressed air container in response to a signal transmitted to a switch 38 that is operated by a remote control device 40 (FIG. 2). In a manner well understood by those skilled in the art, switch 38 is interconnected with a conventional dry cell battery 42 that is housed within housing 16 in the manner shown in FIG. 1 of the drawings. Remote-control device 40, switch 38 and a battery 42 are all readily commercially available and their interconnection and operation is well understood by those skilled in the art.

In operating the apparatus of the invention, the apparatus is positioned at a location in the field where predators such as coyotes have been sited. By rotating a top cover 44, which is rotatably connected to the top wall 18 of the housing, the openings 28 formed in the top cover can be exposed to the particulate matter 30 which is contained within the internal chamber 27 of the housing. With a top cover rotated to the open position, the hunter then takes a position at a suitable remote location from which the apparatus of the invention can be viewed. When suitably in position and at the ready, using the remote control 40, the hunter actuates switch 38 so as to open the valve 36. When valve 36 is opened, compressed air will flow from cylinder 32, through the housing inlet and into a director chamber 48 that is housed within the housing and is in communication with the cylinder 32. Director chamber 48 is so constructed and arranged as to direct the compressed air toward the particulate matter 30 in the manner indicated by the arrows 49 in FIG. 1. The compressed air is adapted to flow from the director chamber 48 toward the particulate matter at a velocity that will cause the particulate matter to effectively disperse and flow through the openings 28 in the manner illustrated in FIG. 1 of the drawings and indicated by the arrows 51. As the particulate matter flows from the housing it will closely simulate a dust cloud, such as one that might be raised by the prey of the coyote and one that will arouse the curiosity of the coyote and cause the coyote to move toward the apparatus. As the coyote nears the apparatus of the invention it will come into the vision of the hunter and within range of the hunter's gun.

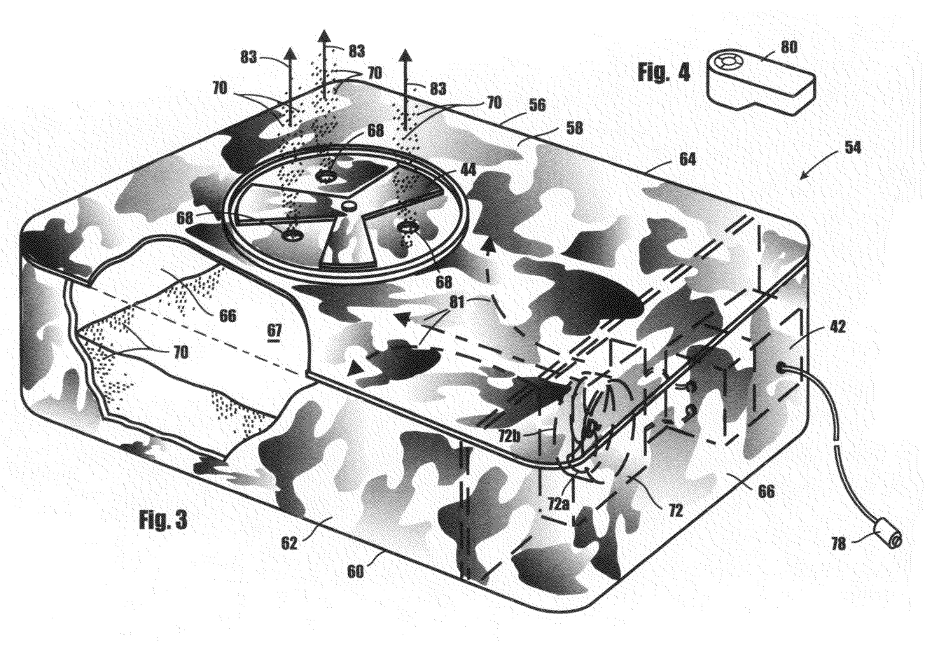

Referring next to FIGS. 3 and 4 of the drawings, an alternative form of the animal decoy apparatus of the present invention is there shown and generally identified by the 54. This alternate form of the apparatus of the invention is similar in many respects to that illustrated in FIGS. 1 and 2 of the drawings and described in the preceding paragraphs and like numerals are used in FIGS. 3 and 4 to identify like components.

The primary difference between this latest form of the invention and the earlier described embodiment resides in the somewhat differently configured dispersing means for dispersing the particulate matter contained within the housing. As best seen in FIG. 3 of the drawings, the animal decoy apparatus 54, which is also well suited for attracting predatory animals, comprises a housing 56 having interconnected top, bottom, front, rear and side walls 58, 60, 62, 64 and 66, respectively. As indicated in FIG. 3, interconnected walls 58, 60, 62, 64 and 66 cooperate to define an interior chamber 67. As before, top wall 58 is provided with a plurality of spaced apart openings 68.

Disposed within interior chamber 67 of housing 56 is a multiplicity of dispersible particulates generally designated by the numeral 70. Particles 70 here comprise fine particles of flour.

Operably associated with housing 56 is particulate dispersing means for acting on the dispersible particulates 70 to urge to be dispersible particulates through the openings 68 in said top wall 58 of the housing. In the embodiment of the invention illustrated in FIGS. 3 and 4, the particulate dispersing means comprises an electric blower 72 of conventional construction that is connected to housing 56 in the manner shown in FIG. 3 of the drawings. Electric blower 72 has a plurality of rotating blades 72a that force air through an outlet 72b that is in communication with the interior chamber 67 of the housing. Blower 72 is interconnected in a manner well understood by those skilled in the art, with a switch 78 that is operated by a remote control device 80 (FIG. 4). In a manner well understood by those skilled in the art, switch 78 is interconnected with a conventional dry cell battery 42 that is housed within housing 56 in the manner shown in FIG. 3 of the drawings.

As in the previously described embodiment of the invention, in use the apparatus is positioned at a location in the field where predators have been sited. By rotating a top cover 44, which is rotatably connected to the top wall 58 of the housing, the openings 68 formed in the top cover can be exposed to the particulate matter 70 which is contained within the internal chamber 67 of the housing. With the top cover rotated to the open position, the hunter then takes a position at a suitable remote location from which the apparatus of the invention can be viewed. When suitably in position and at the ready, using the remote control 80, the hunter actuates switch 78 so as to energize the blower 72. When the blower is energized, air will move toward the particulate matter 70 in the manner indicated by the arrows 81 in FIG. 3. The air will flow at a velocity that will cause the particulate matter to effectively disperse and flow through the openings 68 in the manner illustrated in FIG. 3 of the drawings and indicated by the arrows 83. As the particulate matter flows from the housing it will closely simulate a dust cloud, such as one that might be raised by the prey of a coyote and one that will arouse the curiosity of the coyote and cause the coyote to move toward the apparatus. As the coyote nears the apparatus of the invention it will come into the vision of the hunter and within range of the hunter's gun.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An animal decoy comprising;
(a) a housing having an interior chamber, said housing having at least one wall having an opening therein;
(b) a multiplicity of dispersible particulates disposed within said interior chamber of said housing; and
(c) particulate dispersing means operably associated with said housing for acting on said dispersible particulates to urge said dispersible particulates through said opening in said at least one wall of said housing.

2. The animal decoy as defined in claim 1 in which said particulate dispersing means comprises an electric blower connected to said housing.

3. The animal decoy as defined in claim 1 in which said particulate dispersing means comprises a source of compressed gas connected to said housing.

4. The animal decoy as defined in claim 1 in which said housing comprises interconnected top, bottom, side and end walls, said top wall having an opening therein.

5. The animal decoy as defined in claim 1 in which said dispersible particulates comprise dirt particulates.

6. The animal decoy as defined in claim 1 in which said dispersible particulates comprise flour.

7. An animal decoy comprising:
(a) a housing having interconnected top, bottom, side and end walls defining an interior chamber, said top wall having an opening therein;
(b) a multiplicity of dispersible particulates disposed within said interior chamber of said housing; and
(c) particulate dispersing means operably associated with said housing for acting on said dispersible particulates to urge said dispersible particulates through said opening in said top wall of said housing.

8. The animal decoy as defined in claim 7 in which said dispersible particulates comprise dirt particulates.

9. The animal decoy as defined in claim 7 in which said dispersible particulates comprise flour.

10. The animal decoy as defined in claim 7 in which said particulate dispersing means comprises an electric blower connected to said housing, said electric blower having an outlet in communication with said interior chamber of said housing.

11. The animal decoy as defined in claim 7 in which said particulate dispersing means comprises:
(a) a conduit connected to said housing, said conduit having an inlet and an outlet in communication with said interior chamber of said housing; and
(b) a source of compressed gas connected to said inlet of said housing;

12. The animal decoy as defined in claim 11 in which said particulate dispersing means further comprises a valve disposed between said source of compressed gas and said inlet of said conduit.
